(19) United States
(12) Patent Application Publication
(10) Pub. No.: US 2011/0290286 A1
(43) Pub. Date: Dec. 1, 2011

(54) ULTRASONIC GENERATOR AND ULTRASONIC CLEANSING APPARATUS

(76) Inventor: Keisuke Ohata, Hamura-shi (JP)

(21) Appl. No.: 13/143,992

(22) PCT Filed: Jan. 22, 2010
(86) PCT No.: PCT/JP2010/050785

§ 371 Date: Aug. 8, 2011

(30) Foreign Application Priority Data
Jan. 30, 2009 (JP) 2009-019830

(51) Int. Cl. B08B 3/12; G06F 19/00

(52) U.S. Cl. 134/184; 702/39

(57) ABSTRACT

To provide an ultrasonic generator capable of detecting any of a state operated without a water load, abnormality of an ultrasonic transducer and abnormality of a cleaning bath. The ultrasonic generator according to the present invention includes a signal source 9 for generating a signal having at least one of frequencies of f1, f2 and f3, a matching circuit 17 for matching the signal generated from the signal source, an ultrasonic transducer 2 to which the signal matched by the matching circuit is input, a detection circuit 10 for detecting the voltage value and current value of the signal input to the ultrasonic transducer, an impedance computing unit 11 for computing the impedance to the signal using the voltage value and current value detected by the detection circuit, and a determination part 13 for determining abnormality of the cleaning bath or the ultrasonic transducer by comparing the impedance to the signal computed by the impedance computing unit with a previously-set threshold for detecting an impedance abnormality.

### TECHNICAL FIELD

The present invention relates to an ultrasonic generator, an ultrasonic cleansing apparatus, etc., particularly to an ultrasonic generator, an ultrasonic cleansing apparatus etc. capable of detecting any of a state operated without a water load, abnormality of an ultrasonic transducer and abnormality of the cleaning bath.

### BACKGROUND ART

FIG. 9 shows an anomaly detection apparatus of an ultrasonic transducer conventionally used by a block diagram. Ultrasonic transducers 101a, 101b, 101c and 101d are connected in parallel, which are driven simultaneously by an ultrasonic drive apparatus equipped with a generation circuit 102, a voltage amplification circuit 103, a power amplification circuit 104 and an impedance-matching circuit 105.

Incidentally, in ultrasonic transducers, naturally, such a thing as break down is considered. For example, there are thermal stress breakdown (mainly cracks of ceramic) due to heat generation when an overload is applied to an ultrasonic transducer, breakdown of a bolt or a metal block due to too much excitation when a load is nearly zero, and, in addition, natural break down etc.

When plural ultrasonic transducers are used simultaneously in parallel, for example, even if one ultrasonic transducer among them breaks down, it is not possible to continue the use in that state. If the use is continued, the expected purpose can not be attained, and, in addition, it can not be said that there is no such case that an overcurrent induces the break down of another one.

Consequently, conventionally, as shown in FIG. 9, a sensor (current transformer) 107 for detecting a current value flowing through a main wiring 106 of drive wiring supplying a high frequency power to these ultrasonic transducers is disposed, which detects the current flowing through the main wiring 106 and sends the detected value to a comparison circuit 108. To the comparison circuit 108, the sum of values of current flowing when all the ultrasonic transducers operate normally has been input previously as the reference value. The comparison circuit 108 compares an analog signal indicating the current value from the sensor 107 with an analog value input as the reference value, carries out an AD conversion of the difference between the values, and sends it to a CPU 109. The CPU 109 determines whether or not the input numerical value falls within a previously set range, and, if the value is outside the range, outputs a signal to an alarm device 110. When the alarm device 110 receives the signal from the CPU 109, it displays an alarm of anomaly occurrence in the ultrasonic transducer, and orders to stop the whole apparatus that uses the ultrasonic transducer (see, for example, Patent Document 1).

However, the anomaly detection apparatus shown in FIG. 9 determines only the case where the current given to the ultrasonic transducer becomes an overcurrent as an anomaly, and determines to stop the whole apparatus that uses the ultrasonic transducer. Consequently, there are such cases that the ultrasonic transducer itself has already broken down by the flow of the overcurrent, and that no anomaly can be detected until the ultrasonic transducer breaks down even when the operation is carried out in a state without a water load. The operation without a water load may result in that the ultrasonic transducer becomes in a state of over amplitude, and that the ultrasonic transducer generates heat by the vibration thereof to generate such break down as the peeling in the ultrasonic transducer.

FIG. 10 is a block diagram showing the constitution of a conventional ultrasonic transducer driving apparatus.

A phase difference detection circuit 210 controls the generation frequency of a generation circuit 204 on the basis of the phase difference of the drive voltage and current of an ultrasonic transducer 203. A |Z| minimal value detection circuit 211 controls the generation frequency of the generation circuit 204 on the basis of the impedance of the ultrasonic transducer 203. A state detection circuit 212 detects an anomaly of a load on the basis of the magnitude of the impedance, and adopts the control of the phase difference detection circuit 210 in a normal state, or the control of the |Z| minimal value detection circuit 211 in an abnormal state. This enables reliable resonance point driving by carrying out impedance minimum value tracking mode control, even if resonance point tracking is made impossible due to the fluctuation of the load. Moreover, an alarm generation circuit 213 announces the anomaly of the load. This apparatus is also equipped with a VCA 205, an AMP 206, a drive and detection circuit 207, a setting signal generation part 208, a differential amplifier circuit 209 and a switching part 214 (see, for example, Patent Document 2).

However, since a resonance frequency (one cycle) is given to the ultrasonic transducer, the current and voltage flowing through the ultrasonic transducer is detected, the anomaly of the load is determined on the basis of the magnitude of the impedance, and the control by the |Z| minimal value detection circuit 211 is adopted in an abnormal state, the ultrasonic transducer driving apparatus shown in FIG. 10 has such constitution that the apparatus keeps the operation thereof. That is, the apparatus keeps the operation thereof until the destruction of the ultrasonic transducer. Consequently, the detection of the break down of the ultrasonic transducer is impossible prior to the complete destruction of the ultrasonic transducer.
Patent Document 1: Japanese Patent No. 2983513 (paragraphs [0003] to [0006], FIG. 2)
Patent Document 2: Japanese Patent Application Laid-Open No. 2001-212514 (Abstract, FIG. 1)

### DISCLOSURE OF THE INVENTION

As described above, in conventional apparatuses, the state in which ultrasonic vibration is given without a water load can not be detected early. Moreover, the anomaly of an ultrasonic transducer can not be detected prior to the complete break down of the ultrasonic transducer.

The present invention was accomplished in consideration of the above situation, and aims at providing an ultrasonic generator, an ultrasonic cleansing apparatus etc. capable of detecting any of a state operated without a water load, abnormality of an ultrasonic transducer and abnormality of the cleaning bath.

In order to solve the above-described problem, the ultrasonic generator according to the present invention is an ultrasonic generator equipped with an anomaly detection mechanism for detecting the abnormality of a cleaning bath or an ultrasonic transducer, the generator including:

a signal source for generating a signal having at least one of frequencies of a primary resonance frequency f1, a secondary resonance frequency f2 and a tertiary resonance frequency f3,

a matching circuit for matching the signal generated from the signal source,

an ultrasonic transducer to which the signal matched by the matching circuit is input,

a detection circuit for detecting the voltage value and current value of the signal input to the ultrasonic transducer,

an impedance computing unit for computing the impedance to the signal using the voltage value and current value detected by the detection circuit, and

a determination part for determining abnormality of the cleaning bath or the ultrasonic transducer by comparing the impedance relative to the signal computed by the impedance computing unit with a previously-set threshold for detecting abnormality of impedance.

The ultrasonic generator according to the present invention, preferably, further includes a mechanism for stopping the operation of the ultrasonic transducer when the determination part determines the abnormality of the cleaning bath or the ultrasonic transducer.

In the ultrasonic generator according to the present invention, preferably, each of the primary resonance frequency f1 and the tertiary resonance frequency f3 is a frequency that resonates in a thickness direction of the ultrasonic transducer, and the secondary resonance frequency f2 is a frequency that resonates in a direction parallel to the main surface of the ultrasonic transducer.

In the ultrasonic generator according to the present invention, preferably, the detection circuit detects a voltage value and a current value at a timing when the impedance to the signal becomes the greatest or the smallest, when it detects the voltage value and current value of the signal.

In the ultrasonic generator according to the present invention, preferably, the detection circuit detects a voltage value and a current value at a timing when a phase difference between the voltage value and current value is zero or approaches zero, when it detects the voltage value and current value of the signal.

The ultrasonic cleansing apparatus according to the present invention includes:

any of aforementioned ultrasonic generators, and

a cleaning bath to which the ultrasonic transducer is bonded and in which a cleaning liquid is stored.

The ultrasonic cleansing apparatus according to the present invention includes:

any of aforementioned ultrasonic generators,

a housing to which the ultrasonic transducer is bonded, and

a supply pipe for supplying a propagation liquid in the housing,

the ultrasonic transducer imparting ultrasonic vibration to the propagation liquid supplied in the housing by the supply pipe, and

the propagation liquid to which the ultrasonic vibration is imparted being discharged outside the housing.

As explained above, the present invention can provide an ultrasonic generator, an ultrasonic cleansing apparatus etc. capable of detecting any of a state operated without a water load, abnormality of an ultrasonic transducer and abnormality of the cleaning bath.

### BRIEF DESCRIPTION OF THE DRAWINGS

FIG. 1(A) is an outline view showing an example of the constitution of an ultrasonic cleansing apparatus according to an embodiment of the present invention, and FIG. 1(B) is an outline view showing another example of the constitution of the ultrasonic cleansing apparatus according to an embodiment of the present invention.

FIG. 2 is a constitution diagram for explaining the details of an ultrasonic generator 1 shown in FIGS. 1(A) and 1(B).

FIG. 3 is a drawing showing the impedance |Z| when each of signals of f1, f2 and f3 is input to the piezoelectric element in a state operated without a water load.

FIG. 4 is a drawing showing the impedance |Z| when each of signals f1, f2 and f3 is input to a piezoelectric element in respective states operated with or without a water load.

FIG. 5 is a drawing obtained by enlarging the f1 part shown in FIG. 4.

FIG. 6 is a drawing showing the impedance |Z| when each of signals of f1, f2 and f3 is input to the piezoelectric element in a state operated without a water load.

FIG. 7 is a drawing showing the impedance |Z| and the phase difference θ when each of signals of f1, f2 and f3 is input to the piezoelectric element in a state operated without a water load.

FIG. 8 is a drawing obtained by enlarging the f1 part shown in FIG. 7.

FIG. 9 is a block diagram showing an anomaly detection apparatus of a conventionally used ultrasonic transducer.

FIG. 10 is a block diagram showing the constitution of a conventional ultrasonic transducer driving apparatus.

### BEST MODE FOR CARRYING OUT THE INVENTION

Hereinafter, embodiments of the present invention will be explained with reference to the drawings.

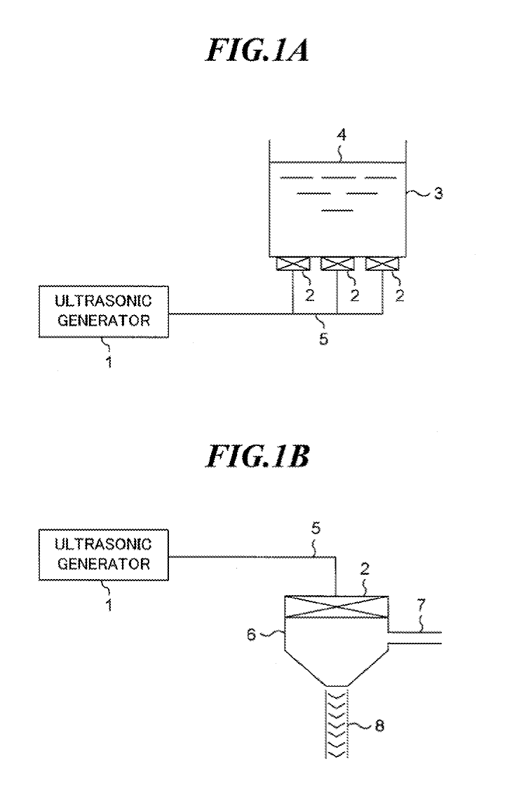

FIG. 1(A) is an outline view showing an example of the constitution of an ultrasonic cleansing apparatus according to an embodiment of the present invention, and FIG. 1(B) is an outline view showing another example of the constitution of the ultrasonic cleansing apparatus according to an embodiment of the present invention.

The ultrasonic cleansing apparatus shown in FIG. 1(A) has a cleaning bath 3 filled with a cleaning liquid 4 for cleaning an object to be cleaned (not shown), and, to the cleaning bath 3, an ultrasonic transducer 2 is attached with an adhesive (not shown). The ultrasonic transducer 2 is connected to the ultrasonic generator 1 by a signal transmission path 5. It is configured so that the ultrasonic signal oscillated by the ultrasonic generator 1 is given to the ultrasonic transducer 2 through the signal transmission path 5, and that the ultrasonic vibration is added to the cleaning liquid 4 in the cleaning bath 3 from the ultrasonic transducer 2.

The ultrasonic cleansing apparatus shown in FIG. 1(B) has the ultrasonic generator 1, and the ultrasonic generator 1 is connected to the ultrasonic transducer 2 by the signal transmission path 5. The ultrasonic transducer 2 is attached to a housing 6 with an adhesive (not shown). It is configured so that a liquid supply pipe 7 is connected to the housing 6, and that the liquid supply pipe 7 supplies a propagation liquid 8 into the housing 6. The ultrasonic signal oscillated by the ultrasonic generator 1 is given to the ultrasonic transducer 2 through the signal transmission path 5, which adds ultrasonic vibration to the propagation liquid in the housing 6 from the ultrasonic transducer 2, and the propagation liquid 8 to which the ultrasonic vibration has been added is discharged toward the lower side of the housing 6. It is configured so that the discharged propagation liquid 8 gives the ultrasonic vibration to the cleaning liquid (not shown) for cleaning an object to be cleaned (not shown).

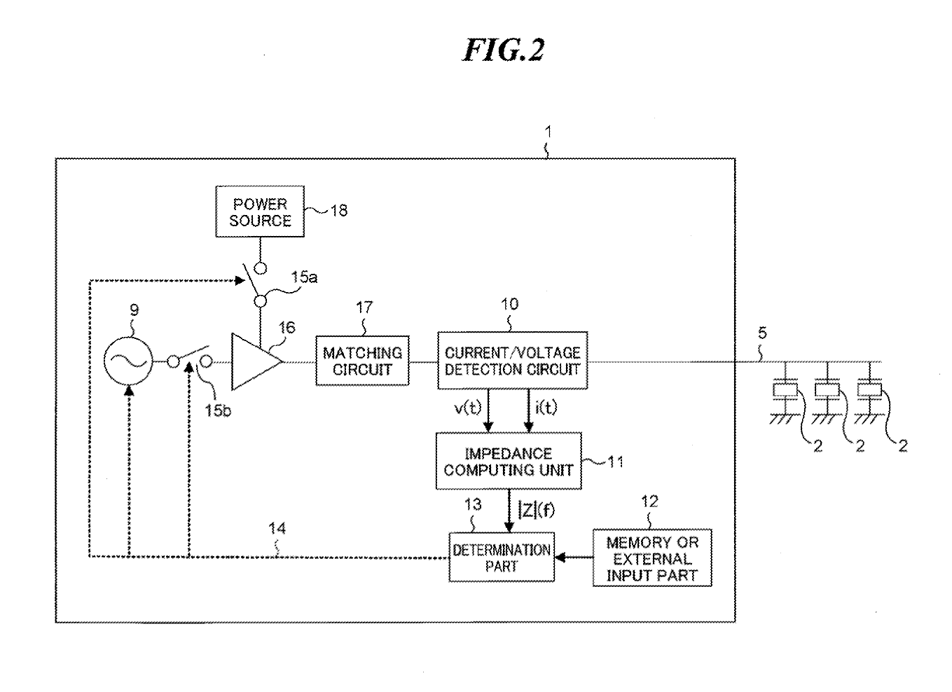

FIG. 2 is a constitution diagram for explaining the details of the ultrasonic generator 1 shown in FIGS. 1(A) and 1(B).

The ultrasonic generator 1 has a power source 18, which is electrically connected to an amplifier 16 via a block mechanism (switch) 15a, and the amplifier 16 is electrically connected to a signal source 9 via a block mechanism (switch) 15b. The block mechanisms 15a and 15b are mechanisms for stopping the generator 1. The signal source 9 can output each signal of the primary resonance frequency f1, the secondary resonance frequency f2 and the tertiary resonance frequency f3.

The amplifier 16 is electrically connected to a matching circuit 17, which is electrically connected to a voltage/current detection circuit 10. The voltage/current detection circuit 10 is electrically connected to plural ultrasonic transducers 2 by the signal transmission path 5. As the ultrasonic transducer 2, an generator made of PZT etc. is used.

The voltage/current detection circuit 10 is electrically connected to an impedance computing unit 11 for computing the impedance, and the impedance computing unit 11 is configured so as to perform the calculation for every frequency by FFT or BPF (band-pass filter) etc. The impedance computing unit 11 is electrically connected to a determination part 13, which is electrically connected to a memory or an external input part 12. Moreover, the determination part 13 is configured so as to input a control signal 14 to each of the signal source 9 and block mechanisms (switches) 15a and 15b.

The determination part 13 is one for determining such break down as whether or not the system is operated without a water load, damage (destruction) is generated in the ultrasonic transducer 2, the quartz plate as the bottom plate of the cleaning bath 3 becomes thin by aged deterioration due to erosion etc., a chipped or cracked portion is generated, etc. The block mechanisms 15a and 15b are ones for stopping the generator 1 when the break down is determined by the determination part 13.

Next, the operation of the ultrasonic generator 1 shown in FIG. 2 will be explained.

A signal having a frequency of at least one of the primary resonance frequency f1, the secondary resonance frequency f2 and the tertiary resonance frequency f3 is generated by the signal source 9, electric power is input to the amplifier 16 by the power source 18, the signal generated by the signal source 9 is amplified by the amplifier 16, the amplified signal is input to the matching circuit 17, and the signal matched by the matching circuit 17 is input to plural ultrasonic transducers 2 through the signal transmission path 5.

The voltage value v(t) and the current value i(t) of the signal input to the ultrasonic transducer 2 are detected by the voltage/current detection circuit 10. On this occasion, preferably the voltage value v(t) and the current value i(t) are detected at a timing when the phase difference between the voltage value v(t) and the current value i(t) is zero or approaches zero, or, preferably the voltage value v(t) and the current value i(t) are detected at a timing when the impedance to the signal becomes the maximum or the minimum. Then, the data of detected voltage value v(t) and current value i(t) are sent to the impedance computing unit 11. While using the voltage value v(t) and the current value i(t), the impedance computing unit 11 calculates impedance |Z| (f) for respective signals of f1, f2 and f3, and the data of impedance |Z| (f) is input to the determination part 13.

To the determination part 13, a threshold for impedance anomaly detection for determining whether or not the break down occurs is previously input and set by a memory or the external input part 12, and the determination part 13 compares the threshold for anomaly detection with the impedance calculated by the impedance computing unit 11. Then, it determines that the break down has not occurred when the calculated impedance is within the threshold, or determines that the break down has occurred when it is outside the threshold. When the determination part 13 determines that the break down has occurred, the control signal 14 is input to the block mechanisms 15a and 15b and the signal source 9 from the determination part 13, each connection of the signal source 9 and the power source 18 to the amplifier 16 is blocked, and the operation of the generator 1 and the vibration of the ultrasonic transducer 2 are stopped.

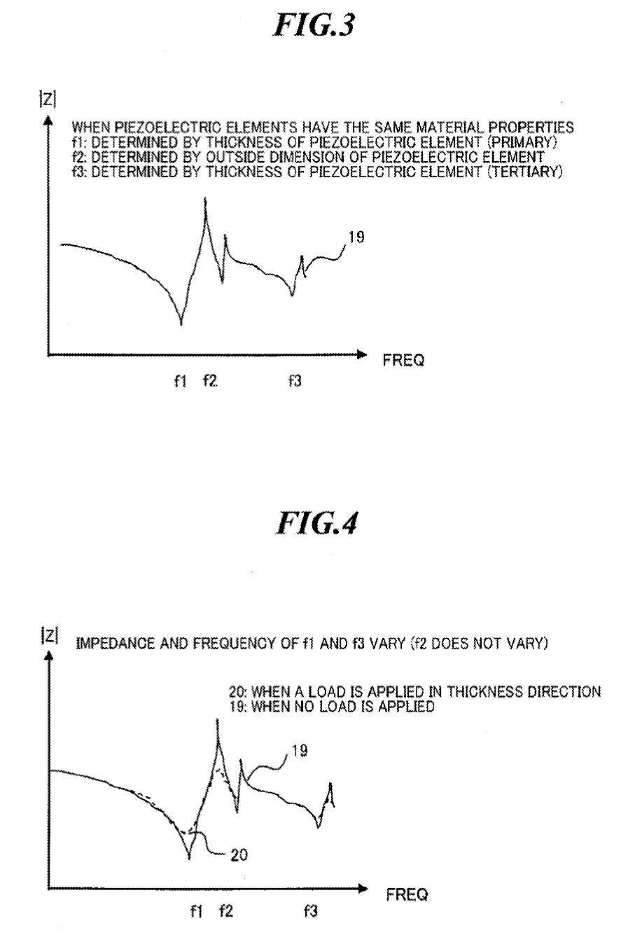

Next, a specific example of determining whether or not the break down has occurred by the determination part 13 will be explained with reference to FIGS. 3 to 6.

Each of FIGS. 3 to 6 is a drawing showing the impedance |Z| when respective signals of the primary resonance frequency f1, the secondary resonance frequency f2 and the tertiary resonance frequency f3 are input to piezoelectric elements (ultrasonic transducers) made of the same material. The f1, f3 here have a frequency for which the impedance is determined by the thickness of the plate-shaped piezoelectric element, in other words, a frequency that resonates in the thickness direction of the plate-shaped piezoelectric element. The f2 has a frequency for which the impedance is determined by the planar outside dimension of the plate-shaped piezoelectric element, in other words, a frequency that resonates in the direction parallel to the main surface (flat surface) (for example, longitudinal and lateral directions of the shape (planar shape) of the main surface) of the plate-shaped piezoelectric element.

A reference numeral 19 shown in FIGS. 3 and 4 shows the impedance when f1, f2 and f3 are input in a state in which no water as the cleaning liquid is kept in the cleaning bath, that is, a state operated without a water load. A reference numeral 20 shown in FIG. 4 shows the impedance when f1, f2 and f3 are input in a state in which water as the cleaning liquid is kept in the cleaning bath, that is, a state operated with a water load.

As shown in FIG. 4, it is known that the impedance and the frequency of f1, f3 change between states operated with or without a water load, but that the impedance and the frequency of f2 do not change.

FIG. 5 is a drawing obtained by enlarging the f1 part shown in FIG. 4. As shown in FIG. 5, the comparison of (|Z|a−|Z|b) in a state without a water load and (|Z|a′−|Z|b′) in a state operated with a water load makes it possible to determine whether or not the system is in a state operated without a water load. That is, by previously setting the (|Z|a′−|Z|b′) of a state with a water load to the determination part 13 as the threshold for anomaly detection and determining whether or not a detected value deviates from the threshold for anomaly detection, it is possible to determine whether or not the system is in a state operated without a water load.

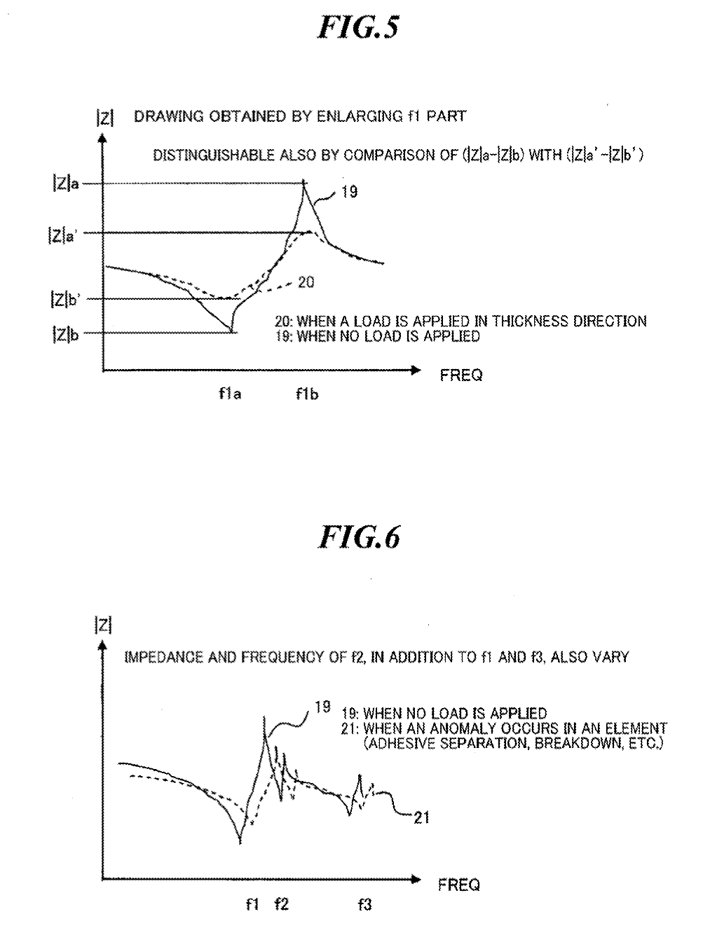

The reference numeral 19 shown in FIG. 6 shows the impedance obtained when f1, f2 and f3 are input to an ultrasonic transducer which is in a state operated without a water load and in which no anomaly is generated. A reference numeral 21 shows an impedance when f1, f2 and f3 are input to an ultrasonic transducer which is in a state operated without a water load and in which an anomaly has occurred (for example, adhesive separation from the cleaning bath or the breakage of the ultrasonic transducer), or to an ultrasonic transducer bonded to a cleaning bath in which anomaly has occurred (for example, a cleaning bath having a thinned bottom plate, a diaphragm having an anomaly, a cleaning bath in which a chipped or cracked portion is generated).

As shown in FIG. 6, it is known that an ultrasonic transducer etc. in which an anomaly has occurred shows the change in the impedance and the frequency of f2, not only in the impedance and the frequency of f1, f3, as compared with one in which no anomaly has occurred. Accordingly, by setting previously the impedance of the reference numeral 19 shown in FIG. 6 as the threshold for anomaly detection in the determination part 13, and determining whether or not a detected impedance deviates from the threshold for anomaly detection in the determination part 13, it becomes possible to determine such break down that a breakage has occurred in the ultrasonic transducer 2, the quartz plate as the bottom plate of the cleaning bath is thin, a chipped or cracked portion is generated in the cleaning bath, etc.

For example, when the tolerance of the thickness of the quartz plate as the bottom plate of the cleaning bath is 2.9 to 3.1 mm, by setting previously a threshold for an anomaly detection of the impedance which falls within the tolerance in the determination part 13, and determining whether or not a detected impedance deviates from the threshold for anomaly detection by the determination part 13, it is possible to determine whether or not the quartz plate is thinned. Moreover, it also becomes possible to detect the replacing timing of the cleaning bath by detecting an expecting degree of the deviation from the threshold for anomaly detection.

Moreover, from the deviation degree of the impedance from the threshold for anomaly detection, the management of generation unevenness caused by the variation in every cleaning bath or ultrasonic transducer becomes possible and the practice of the management can stabilize the cleaning quality of the object to be cleaned.

Moreover, from the deviation degree of the impedance from the threshold for anomaly detection, the determination of the deterioration of the ultrasonic transducer becomes possible, and the detection of an expecting deviation degree of the impedance from the threshold for anomaly detection also makes it possible to detect the replacing timing of the ultrasonic transducer.

Furthermore, it is also possible to determine a case where a part of cables among cables connected to plural ultrasonic transducers 2 from the signal transmission path 5 shown in FIG. 2 are broken, from the threshold for anomaly detection of the impedance.

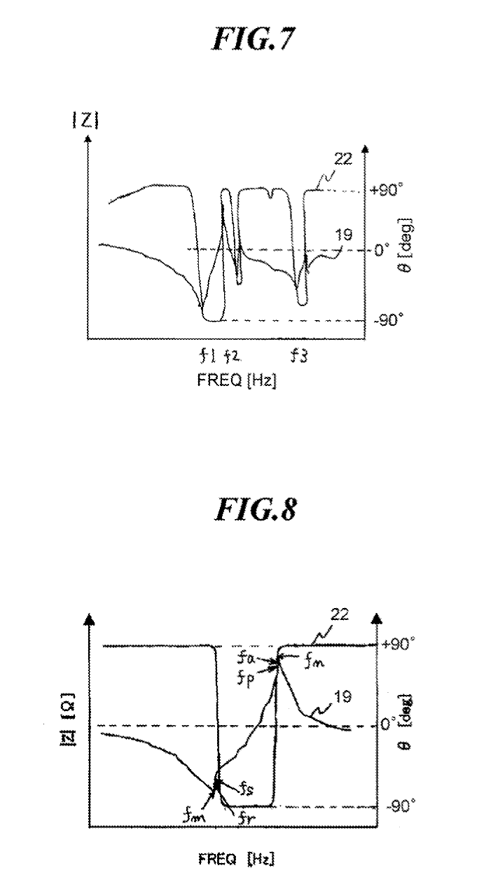

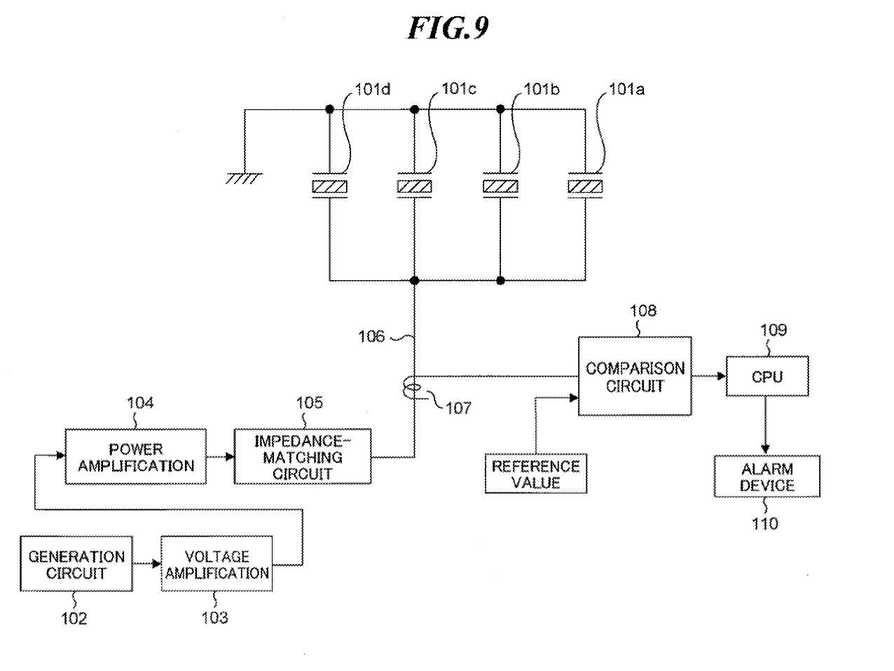

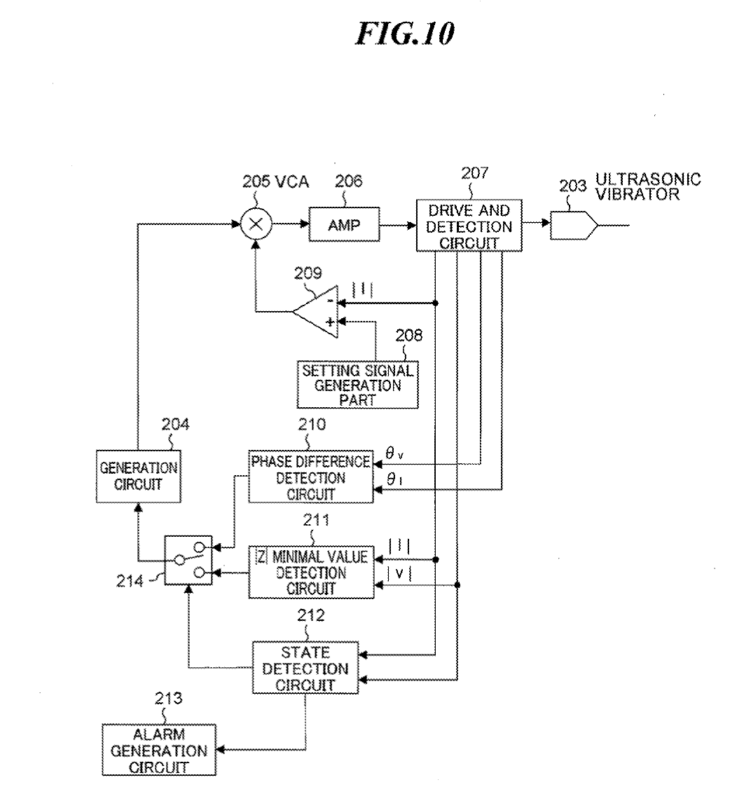

Next, the timing of detecting the voltage value v(t) and the current value i(t) by the voltage/current detection circuit 10 shown in FIG. 2 will be explained with reference to FIGS. 7 and 8.

Each of FIGS. 7 and 8 is a drawing showing the impedance |Z| and the phase difference θ when respective signals of the primary resonance frequency f1, the secondary resonance frequency f2 and the tertiary resonance frequency f3 are input to piezoelectric elements (ultrasonic transducers) made of the same material. FIG. 8 is a drawing obtained by enlarging a part of the f1 part shown in FIG. 7. That is, FIG. 7 shows a wide band of the frequency, and FIG. 8 shows a narrow band (vicinity of f1) of the frequency.

The reference numeral 19 shown in FIGS. 7 and 8 denotes the impedance when the f1, f2 and f3 are input in a state operated without a water load. The reference numeral 22 denotes the phase difference θ between the voltage value v(t) and the current value i(t) when the f1, f2 and f3 are input in a state operated without a water load.

The phase difference θ is represented by a formula below.

The phase difference θ:

θ=(ξ−ψ)

when

v(t)=Vm×sin(ωt+ξ)

i(t)=Im×sin(ωt+ψ)

where Vm is the maximum voltage, Im is the maximum current, ξ is the leading phase of the voltage, ψ is the leading phase of the current, ω is an angle and t is time.

In a case where the detection of mechanical resonance frequencies fs, fp that are actual vibration cycles of the generator shown in FIG. 8 is difficult, when detecting the voltage value v(t) and the current value i(t) of a signal by the voltage/current detection circuit 10, preferably the voltage value v(t) and the current value i(t) are detected at a timing when the impedance to the signal becomes the maximum or the minimum. That is, preferably the voltage value v(t) and the current value i(t) are detected by the voltage/current detection circuit 10 to detect a frequency fn that gives the maximum impedance to the signal, or a frequency fm that gives the minimum impedance to the signal.

Moreover, in a case where the detection of mechanical resonance frequencies fs, fp that are actual vibration cycles of the generator shown in FIG. 8 is difficult, when detecting the voltage value v(t) and the current value i(t) of a signal by the voltage/current detection circuit 10, preferably the voltage value v(t) and the current value i(t) are detected at a timing when the phase difference between the voltage value v(t) and the current value i(t) is zero or approaches zero. That is, preferably the voltage/current detection circuit 10 detects the voltage value v(t) and the current value i(t), and detects the frequency at which the phase difference θ between them is zero or approaches zero. The frequency at which the phase difference θ is zero or approaches zero is a frequency at which the phase difference θ exists between −90° to +90°.

Moreover, in a case where the detection of mechanical resonance frequencies fs, fp that are actual vibration cycles of the generator shown in FIG. 8 is difficult, when detecting the voltage value v(t) and the current value i(t) of a signal by the voltage/current detection circuit 10, preferably the voltage value v(t) and the current value i(t) are detected at a timing when the phase difference between the voltage value v(t) and the current value i(t) becomes the maximum or the minimum. That is, preferably the voltage/current detection circuit 10 detects the voltage value v(t) and the current value i(t), and detects the frequency fa at which the phase difference θ between them becomes the maximum, or the frequency fr at which the phase difference θ becomes the minimum.

Meanwhile, the relation between fs (mechanical series resonance frequency), fp (mechanical parallel resonance frequency), fn (frequency giving the maximum impedance), fm (frequency giving the minimum impedance), fa (frequency giving the largest phase difference θ), and fr (frequency giving the smallest phase difference θ) is represented by formulae below.

fm<fs<fr

fa<fp<fn

According to the above-mentioned embodiment, when the determination part 13 determines that the aforementioned break down occurs, the determination part 13 inputs the control signal 14 to the block mechanisms 15a, 15b and the signal source 9, to make it possible to stop the operation of the generator 1 and the vibration of the ultrasonic transducer 2. Accordingly, it is possible to detect early an operation state in which the ultrasonic vibration is given without a water load, to detect early the anomaly of the ultrasonic transducer prior to the complete break down of the ultrasonic transducer 2, and to detect early the defect etc. of the cleaning bath 3.

Incidentally, the present invention is not limited to the above-mentioned embodiments, and can be practiced with various changes in a range that does not deviate from the gist of the present invention.
1: ultrasonic generator
2: ultrasonic transducer
3: cleaning bath
4: cleaning liquid
5: signal transmission path
6: housing
7: liquid supply pipe
8: propagation liquid
9: signal source
10: current/voltage detection circuit
11: Impedance computing unit
12: memory or external input part
13: determination part
14: control signal
15a, 15b: block mechanism (switch)
16: amplifier
17: matching circuit
18: power source
19: impedance when f1, f2 and f3 are input in a state operated without a water load
20: impedance when f1, f2 and f3 are input in a state operated with a water load
21: impedance when f1, f2 and f3 are input in a state operated without a water load to a ultrasonic transducer in which anomaly has occurred, or to a ultrasonic transducer bonded to a cleaning bath in which anomaly has occurred
22: phase difference θ when f1, f2 and f3 are input in a state operated without a water load

1. An ultrasonic generator equipped with an anomaly detection mechanism for detecting abnormality of a cleaning bath or an ultrasonic transducer, said ultrasonic generator comprising:
a signal source for generating a signal having at least one of frequencies of a primary resonance frequency f1, a secondary resonance frequency f2 and a tertiary resonance frequency f3,
a matching circuit for matching said signal generated from said signal source,
an ultrasonic transducer to which the signal matched by said matching circuit is input,
a detection circuit for detecting the voltage value and current value of said signal input to said ultrasonic transducer,
an impedance computing unit for computing the impedance to said signal using said voltage value and current value detected by said detection circuit, and
a determination part for determining abnormality of said cleaning bath or said ultrasonic transducer by comparing the impedance relative to said signal computed by said impedance computing unit with a previously-set threshold for detecting abnormality of impedance.

2. The ultrasonic generator according to claim 1, further comprising a mechanism for stopping the operation of the ultrasonic transducer when said determination part determines the abnormality of said cleaning bath or said ultrasonic transducer.

3. The ultrasonic generator according to claim 1, wherein each of said primary resonance frequency f1 and said tertiary resonance frequency f3 is a frequency that resonates in a thickness direction of said ultrasonic transducer, and said secondary resonance frequency f2 is a frequency that resonates in a direction parallel to the main surface of said ultrasonic transducer.

4. The ultrasonic generator according to claim 1, wherein said detection circuit detects a voltage value and a current value at a timing when the impedance to the signal becomes the greatest or the smallest, when it detects the voltage value and current value of said signal.

5. The ultrasonic generator according to claim 1, wherein said detection circuit detects a voltage value and a current value at a timing when a phase difference between said voltage value and current value is zero or approaches zero, when it detects the voltage value and current value of said signal.

6. An ultrasonic cleansing apparatus comprising:
the ultrasonic generator according to claim 1, and
a cleaning bath to which said ultrasonic transducer is bonded and in which a cleaning liquid is stored.

7. An ultrasonic cleansing apparatus comprising:
the ultrasonic generator according to claim 1,
a housing to which said ultrasonic transducer is bonded, and
a supply pipe for supplying a propagation liquid in said housing,
said ultrasonic transducer imparting ultrasonic vibration to said propagation liquid supplied in said housing by said supply pipe, and
said propagation liquid to which the ultrasonic vibration is imparted being discharged outside said housing.
